(19) United States
(12) Patent Application Publication
(10) Pub. No.: US 2009/0122426 A1
(43) Pub. Date: May 14, 2009

(54) CAMERA MODULE

(75) Inventor: SU-JEN CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/100,296

(22) Filed: Apr. 9, 2008

(30) Foreign Application Priority Data
Nov. 9, 2007 (CN) 200710202456.6

(51) Int. Cl. G02B 7/02

(52) U.S. Cl. 359/819

(57) ABSTRACT

A camera module includes a circuit board, an image sensor chip, a lens module and a connecting member. The image sensor chip is disposed on the circuit board. The connecting member is adhered to the circuit board and surrounds the image sensor chip. The connecting member has four sidewalls, and a bottom wall connected with the four sidewalls. A protrusion extends upward from a top portion of each sidewall. The lens module includes a lens holder, a lens barrel partially received in and engaged with the lens holder and at least one lens received in the lens barrel. The lens holder defines four corresponding recesses formed on a bottom portion thereof and receives the protrusions therein. Thus, the lens holder of the lens module can be detachably fixed on the connecting member.

### BACKGROUND

1. Technical Field

The present invention relates to the art of camera modules and, particularly, to a camera module which can be easily assembled and disassembled.

2. Description of Related Art

Because of advances in micro-circuitry and multimedia technology, digital cameras are now in wide use. Portable electronic devices, such as mobile phones and Personal Digital Assistants, are being developed to be increasingly multi-functional. Many of these portable electronic devices are equipped with digital cameras. To facilitate portability, such portable electronic devices tend to be compact, slim, and light. Accordingly, the digital cameras that are incorporated into these portable electronic devices have also been reduced in size and weight, and yet remain cost-effective.

Referring to FIG. 7, a typical camera module 100 includes a circuit board 30, an image sensor chip 20, a lens module 10 and a transparent cover 15. The circuit board 30 includes a supporting surface 31. The image sensor chip 20 is disposed on the supporting surface 31 via glue 18. The supporting surface 31 has a number of board pads 301 formed thereon, and the image sensor chip 20 has a number of corresponding chip pads 201 formed thereon. Each chip pad 201 is electrically connected to the corresponding board pads 301 via a wire 19. The lens module 10 includes a lens barrel 12, a lens holder 14 and two lens 16 received in the lens barrel 12. The lens barrel 12 is partially received in and engaged with the lens holder 14. The transparent cover 15 is adhered to a lower surface 121 of the barrel 12 via the glue 18. The lens holder 14 is adhered to the supporting surface 31 of the circuit board 30 via the glue 18.

However, it is time consuming to assemble the lens holder 14 to the circuit board 30. In addition, it is difficult to disassemble the holder 14 from the circuit board 30. Thus, when the image sensor chip 20 is contaminated by dust, the camera module must be wholly replaced in order to continue to provide good quality images.

Therefore, what is desired is a camera module that can overcome the above described problems.

### SUMMARY

In accordance with an embodiment, a camera module includes a circuit board, an image sensor chip, a lens module, and a connecting member. The image sensor chip is disposed on the circuit board. The connecting member is adhered to the circuit board and surrounds the image sensor chip. The connecting member has four sidewalls, and a bottom wall connected with the four sidewalls. A protrusion extends upward from a top portion of each sidewall. The lens module includes a lens holder, a lens barrel partially received in and engaged with the lens holder and at least one lens received in the lens barrel. The lens holder defines four corresponding recesses formed on a bottom portion thereof and receives the protrusions therein.

Other advantages and novel features will be drawn from the following detailed description of at least one present embodiment, when considered in conjunction with the attached drawings.

### BRIEF DESCRIPTION OF THE DRAWINGS

Many aspects of the present camera module can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic exploded, isometric view of a camera module including a connecting member, and a lens holder, according to a first exemplary embodiment.

FIG. 2 is an inverted isometric view of the connecting member of the camera module of FIG. 1.

FIG. 3 is an inverted isometric view of the lens holder of the camera module of FIG. 1.

FIG. 4 is an assembled, isometric view of the camera module of FIG. 1.

FIG. 5 is a cross-sectional view of the camera module of FIG. 4 taken along line V-V.

FIG. 6 is an exploded, perspective view of the camera module according to a second exemplary embodiment.

FIG. 7 is a schematic, cross-sectional view of a camera module in related art.

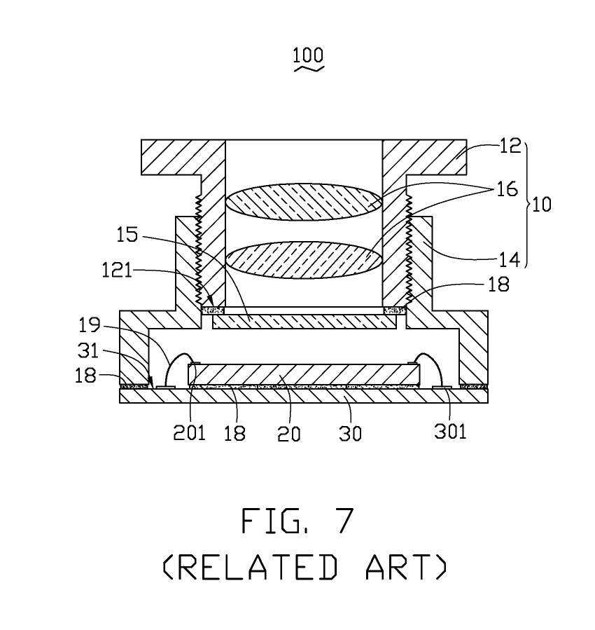

### DETAILED DESCRIPTION OF THE EMBODIMENTS

Embodiments of the present camera module will be now described in detail with reference to the drawings.

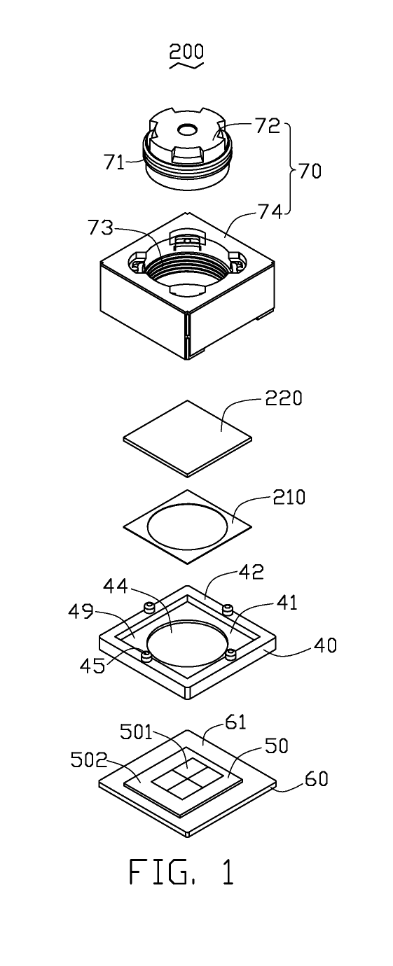

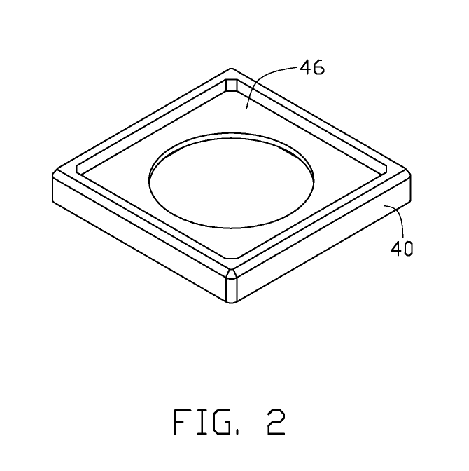

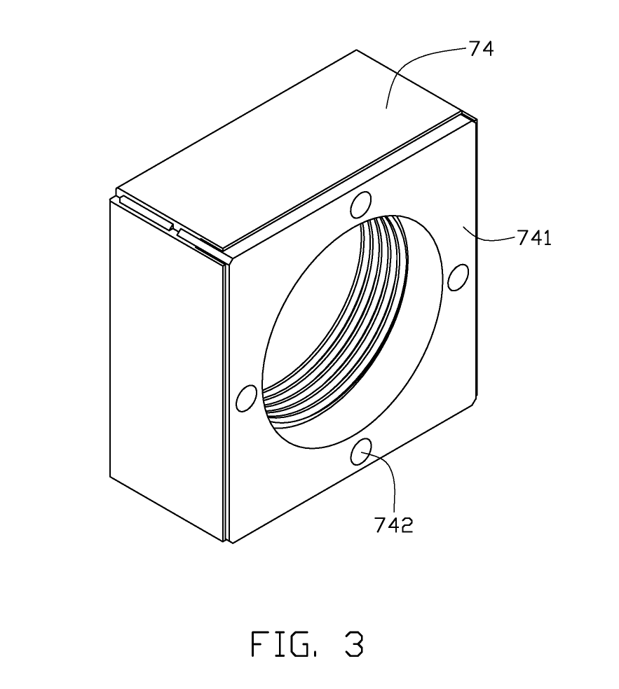

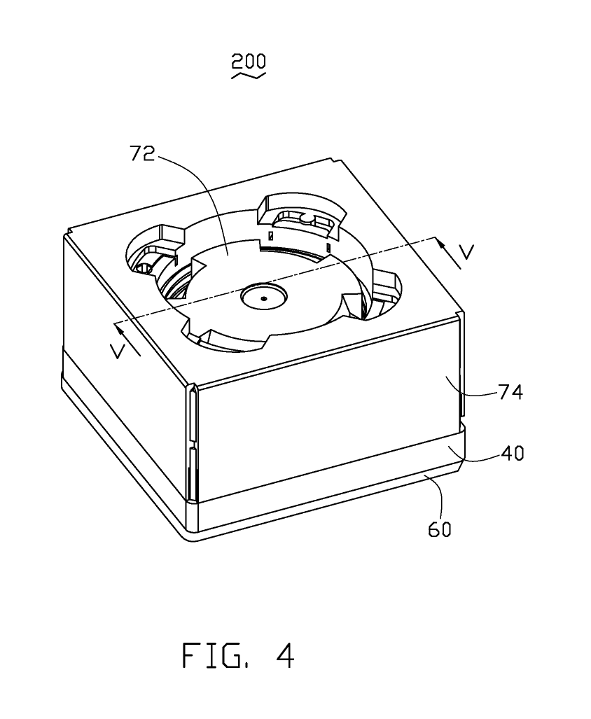

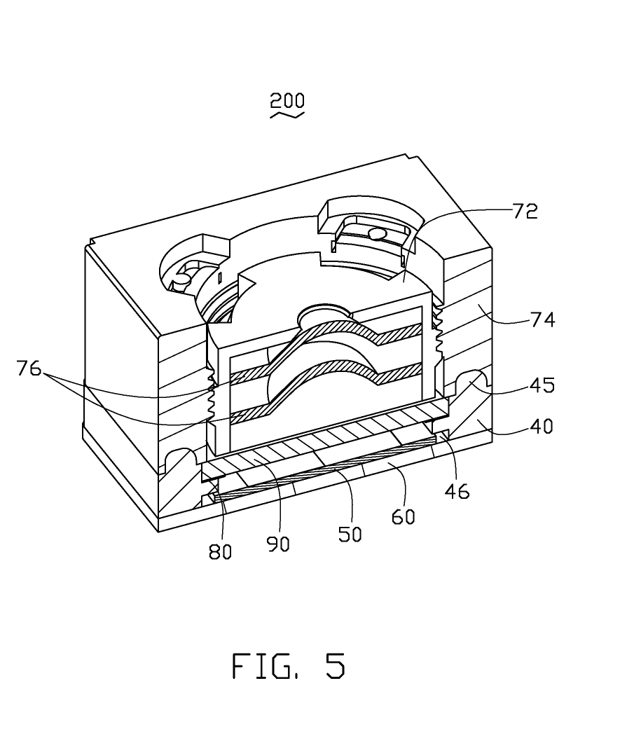

Referring to FIG. 1 to FIG. 5, a camera module 100, according to a first exemplary embodiment, includes a circuit board 60, an image sensor chip 50, a connecting member 40, a transparent cover 220, and a lens module 70.

The circuit board 60 is made of a material such as: polyimide, ceramic, or glass fiber. The circuit board 60 defines a supporting surface 61 for engaging with the image sensor chip 50.

The image sensor chip 50 is a charged coupled device (CCD), or a complementary metal-oxide-semiconductor transistor(CMOS). The image sensor chip 50 is configured to convert light signals received from the lens module 70 into digital electrical signals. The image sensor chip 50 is assembled on the supporting surface 61 of the circuit board 60, by a packaging process, for example, a chip-scale packaging process, a wafer-level chip-scale packaging process, a ceramic leaded packaging process, a plastic leadless chip packaging process, a thermal compression bonding process, or a flip chip packaging process. The image sensor chip 50 has a photosensitive area 501 formed on a top surface 502 thereof. The photosensitive area 501 is configured for receiving light signals transmitted through the lens module 70.

The connecting member 40 is a hollow square frame structure, including four sidewalls 42, and a bottom wall 49 connected with the four sidewalls 42. The connecting member 40 mounted on the supporting surface 61 of the circuit board 60 and surrounding the image sensor chip 60. In the illustrated embodiment, the bottom wall 49, together with the four sidewalls 42, define two cavities (e.g., a first cavity 41 and an opposite second cavity 46). A depth of the first cavity 41 is substantially equal to a thickness of the transparent cover 220. A depth of the second cavity 46 is greater than or equal to a thickness of the image sensor chip 50. The second cavity 46 receives the image sensor chip 50 therein.

The bottom wall 49 defines a circular through opening 44 thereon. The size of the through opening 44 is larger than or equal to that of the photosensitive area 501 of the image sensor chip 50 for letting light transmitted from the lens module 70 therethrough.

Four protrusions 45 are integrally formed with and extend upward from the four sidewalls 42 of the connecting member 40. Alternately, the four protrusions 45 and the sidewalls 42 may be separately formed. The protrusions 45 can be attached to the sidewalls 42 by adhesive, welding (e.g., plastic welding), or other attaching methods. All of the protrusions 45 have essentially identical height to promote even loading thereon. In other embodiments, the four protrusions 45 are respectively located on/at the four corners of the sidewalls 42.

A transparent cover 220, such as an infrared cut filter, is provided between the image sensor chip 50 and the lens module 70 and is configured for protecting the photosensitive area 51 from contamination and filtering light from the lens module 70. The transparent cover 220 is positioned on the bottom wall 49 by a bonding layer 210. The bonding layer 210 can be made of an adhesive material, for example, a silicone, epoxy, acrylic, or polyamide adhesive. Alternatively, the transparent cover 220 may be directly fixed to the lens module 70. The transparent cover 220 can be an optical glass plate or other such transparent element.

The lens module 70 includes at least one lens 76, a lens barrel 72, and a lens holder 74. The lens barrel 72 is a hollow cylinder configured for receiving the at least one lens 76 therein. The lens 76 is made of optical glass or plastic. The lens barrel 72 has external threads 71 defined on an external wall thereof, while the lens holder 74 has internal threads 73 defined on an internal wall thereof, thereby the lens barrel 72 is capable of being received in and engaged with the lens holder 74. The lens holder 74 comprises a bottom portion 741 facing the image sensor chip 50. The bottom portion 741 defines four receiving recesses 742 corresponding with the four protrusions 45 of the connecting member 40. When assembling, the protrusions 45 are inserted into the receiving recesses 742 via the pinch fitted method to firmly attach the lens module 70 onto the connecting member 40. Thereby, the lens module 70 is assembled with the circuit board 60. When disassembling, the protrusions 45 are detached from the receiving recesses 742 via pulling the connecting member 40 along a direction away from the lens module 70 or pulling the lens module 70 along a direction away from the connecting member 40.

Alternatively, the receiving recesses 742 may be defined in the sidewalls 42, and the protrusions 45 formed on the lens holder 74. The transparent cover 220 can be directly received in the lens barrel 74 of the lens module 70.

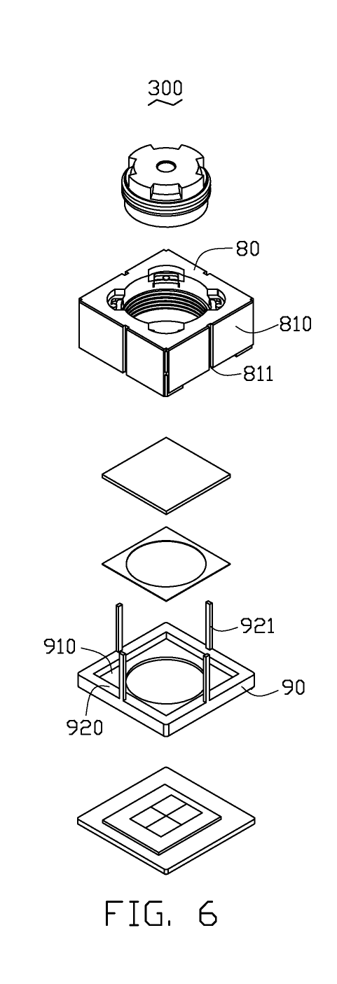

FIG. 6 illustrates a camera module 300, in accordance with a second exemplary embodiment. The camera module 300 is essentially similar to the camera module 200 in the first embodiment, except for a connecting member 90 and a lens holder 80. In this embodiment, four projections 921 respectively protrude out of the edges of the sidewalls 920 along a direction substantially perpendicular to the edges of the sidewalls 920. The lens holder 80 includes four mutually adjacent sidewalls 810. Each sidewall 810 defines a slot 811 to receive the corresponding projection 921 to firmly attach the lens holder 80 onto the sidewalls 920 of the connecting member 90.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

1. A camera module comprising:
a circuit board;
an image sensor chip disposed on the circuit board;
a connecting member mounted on the circuit board and surrounding the image sensor chip, the connecting member having four sidewalls and a bottom wall connected with the four sidewalls; and
a lens module having a lens holder, a lens barrel partially received in and engaged with the lens holder and at least one lens received in the lens barrel, the lens module being optically aligned with the image sensor chip and detachably fixed on the connecting member.

2. The camera module as claimed in claim 1, wherein at least two protrusions are integrally formed with the sidewalls located on/at the sidewalls, the lens holder having a bottom portion facing the image sensor chip, the bottom portion defining at least two receiving recesses corresponding with the at least two protrusions, the at least two protrusions and the at least two receiving recesses respectively matching each other to firmly attach the lens module onto the sidewalls of the connecting member.

3. The camera module as claimed in claim 1, wherein at least two receiving recesses are defined in the sidewalls, at least two protrusions are formed on the lens holder, the at least two protrusions and the at least two receiving recesses being respectively matched with each other to firmly attach the lens module onto the sidewalls of the connecting member.

4. The camera module as claimed in claim 1, wherein the sidewalls of the connecting member protruding at least two projectors that respectively protrude out of an edge of the sidewalls along a direction substantially perpendicular to the edges of the sidewalls, the lens holder having adjacent sidewalls, each adjacent sidewall defining a slot to receive the projector to firmly attach the lens holder onto the sidewalls of the connecting member.

5. The camera module as claimed in claim 1, wherein the connecting member being positioned on the circuit board by adhesive.

6. The camera module as claimed in claim 1, wherein the bottom wall together with the four sidewalls defines a first cavity and an opposite second cavity.

7. The camera module as claimed in claim 6, wherein the camera module further comprises a transparent cover and bonding layer, a depth of the first cavity substantially equaling to a thickness of the transparent cover, the transparent cover being positioned on the bottom wall by the bonding layer, the second cavity receiving and surrounding the image sensor chip.

8. The camera module as claimed in claim 7, wherein the image sensor chip has a photosensitive area, the bottom wall defines a through opening thereon, the size of the through opening is larger than that of the photosensitive area.

9. A camera module comprising:
a circuit board;
an image sensor chip disposed on the circuit board;
a connecting member mounted on the circuit board and surrounding the image sensor chip, the connecting member comprising four sidewalls and a first latching portion formed on the four sidewalls; and
a lens module comprising a lens holder and being optically aligned with the image sensor chip, the lens holder comprising a second latching portion capable of latching with the first latching portion of the connecting member to detachably fix the lens module on the connecting member.

10. The camera module as claimed in claim 9, wherein the first latching portion comprises at least two protrusions formed on the sidewalls, the lens holder having a bottom portion facing the image sensor chip, the second latching portion comprises at least two receiving recesses corresponding with the at least two protrusions defined in the bottom portion of the lens holder to receive the at least two protrusions to firmly attach the lens module onto the connecting member.

11. The camera module as claimed in claim 9, wherein the first latching portion comprises at least two receiving recesses defined in the sidewalls, the second latching portion comprises at least two protrusions formed on the lens holder for being received in the at least two receiving recesses to firmly attach the lens module onto the connecting member.

12. The camera module as claimed in claim 9, wherein the first latching portion comprises at least two projectors protruding from the sidewalls of the connecting member, the lens holder comprises adjacent sidewalls, the second latching portion comprises at least two slots defined in the sidewalls to receive the at least two projectors to firmly attach the lens holder onto the connecting member.

13. The camera module as claimed in claim 9, wherein the at least two projectors are respectively protruding out of an edge of the sidewalls along a direction substantially perpendicular to the edges of the sidewalls.

14. The camera module as claimed in claim 9, wherein the connecting member is positioned on the circuit board by adhesive.

15. The camera module as claimed in claim 9, wherein the connecting member further comprises a bottom wall connected with the four sidewalls, the bottom wall together with the four sidewalls defines a first cavity and an opposite second cavity.

16. The camera module as claimed in claim 15, wherein the camera module further comprises a transparent cover and bonding layer, a depth of the first cavity is substantially equal to a thickness of the transparent cover, the transparent cover is positioned on the bottom wall by the bonding layer, the second cavity receives and surrounds the image sensor chip.

17. The camera module as claimed in claim 16, wherein the image sensor chip has a photosensitive area, the bottom wall defining a through opening therein, the size of the through opening is substantially larger than or equal to that of the photosensitive area.
